(19) United States
(12) Patent Application Publication
(10) Pub. No.: US 2026/0105092 A1
(43) Pub. Date: Apr. 16, 2026

(54) METHODS AND SERVERS FOR TRIGGERING QUERY ANSWERS

(71) Applicant: Y.E. Hub Armenia LLC, Yerevan (AM)

(72) Inventors: Andrei AKSHONOV, Moscow (RU); Daniil GUSEV, Dzerzhinsk (RU); Aleksandr IUSHKEVICH, Moscow (RU)

(21) Appl. No.: 19/359,622

(22) Filed: Oct. 15, 2025

(30) Foreign Application Priority Data
Oct. 15, 2024 (RU) 2024130990

(51) Int. Cl. G06F 16/334; G06F 16/3332; G06F 16/335; G06F 16/35; G06N 20/00

(52) U.S. Cl. CPC G06F 16/3344; G06F 16/3338; G06F 16/335; G06F 16/35; G06N 20/00

(57) ABSTRACT

A method of triggering a query answer, executable by a server communicatively coupled with a user device, the method comprising: acquiring a user query in natural language; ranking documents based on respective document-query relevance scores, the document-query relevance scores being indicative of document relevance to the query; determining, for top N documents from the ranking, respective document-answer relevance scores using a first machine learning model, the respective document-answer relevance scores being indicative of how likely content from the documents satisfies the query; re-ranking the top N documents based on document-answer relevance scores; generating, using a second machine learning model, a query answer in natural language based on content snippets from top M documents from the re-ranking; and triggering display of the query answer on the user device.

### CROSS-REFERENCE

The present application claims priority to Russian Patent Application No. 2024130990, entitled “Methods and Servers for Triggering Query Answers”, filed Oct. 15, 2024, the entirety of which is incorporated herein by reference.

### FIELD

The present technology is generally related to web search engines, and more specifically, to methods for using large language models with web search engines to generate answers.

### BACKGROUND

Traditional web search engines rely on a process involving web crawling, indexing, and document retrieval to find answers to user queries. Web crawlers traverse the internet, gathering data from websites in various formats such as text, images, and videos. This data is then processed and stored in an index. When a user submits a query, the search engine matches the query to indexed data, providing a list of ranked documents.

Search engines can be integrated in services that use a dialogue data-based large language model (LLM) for offering an integrated solution for information retrieval. Such systems leverage the natural language understanding of LLMs to process complex and nuanced user queries, while simultaneously querying search engines for data. This dual approach allows users to ask detailed or multi-part questions in a conversational style, with the LLM interpreting the context and intent behind the query. The search engine component may be leveraged to provide up-to-date information from the web to the LLM, which can be useful for time-sensitive or domain-specific inquiries. The LLM synthesizes the search results into coherent, contextually relevant answers, reducing the need for users to manually sift through multiple sources. It also allows for follow-up questions, refining the search process through dynamic conversation, unlike traditional search engines. However, generating answers based on the search engine content may be complex due to the amount and variety of content that a search engine can provide.

The present specification aims to improve the performance of dialogue data-based LLMs integrated with search engines.

### SUMMARY

Developers have devised methods and devices for overcoming at least some drawbacks present in prior art solutions.

Developers of the present technology have realized that traditional web search engines have limitations. These engines present links that users must sift through to find relevant information. While some enhancements have been introduced, such as snippets that display short text excerpts and quick answers for simple queries, the basic mechanism remains unchanged. Queries which require synthesizing information from multiple sources, are not adequately addressed by these traditional search engines. For instance, a query such as “which plants can live in a dark room and do not require daily watering” or “is it worth going to Namibia in autumn and what to do there” typically returns fragmented results, leaving users to manually gather and compile the information.

Developers have realized that recent development of LLMs, including Generative Pre-trained Transformer (GPT)-like models, provides a potential for improving performance of web search engines in terms of handling query. LLMs generate answers by analyzing and synthesizing information from multiple sources. Unlike conventional search engines, LLMs can provide more detailed answers to nuanced questions by examining vast amounts of text data. However, LLMs also have limitations. A key limitation is their tendency to generate fabricated or hallucinated answers, where information is invented rather than derived from verified sources. Additionally, LLMs are typically trained on static data, rendering them less effective in providing real-time, up-to-date information.

Developers have realized at least some advantages of combining traditional web search engines with LLMs. While web search engines are able to retrieve relevant documents and present them in a ranked format, they struggle with information synthesis and contextual understanding. On the other hand, LLMs can analyze and aggregate content from multiple documents but lack the ability to provide real-time, verifiable data.

Developers have realized that, given these limitations, there is a need for a search technology that combines the strengths of traditional web search engines with the capabilities of LLMs.

Developers have designed a method for enhancing search result accuracy of web search engines using neural models, rephrasing user queries, and synthesizing real-time data from multiple sources.

The present technology may have a variety of advantages. Some embodiments of the present technology may reduce computational resources during query processing by using a model that ranks documents without generating potential answers in real time to determine which document contains the content needed to generate the best answer. Some embodiments of the present technology may improve search result accuracy by rephrasing user queries, such that the user's intent is captured from the context of the query. Additionally, some embodiments of the present technology may integrate multiple sources to generate answers, reducing the need for users to manually sift through various documents. Furthermore, some embodiments of the present technology may provide real-time data, such that the answers are up-to-date and contextually relevant. Furthermore, some embodiments of the present technology may help maintaining factual accuracy by linking each part of the answer to its source, allowing for easy verification.

Some implementations of the present technology can be used by search engine providers, artificial intelligence (AI)-driven virtual assistants, customer service platforms, educational tools, and content recommendation systems.

In a first broad aspect of the technology, there is provided a method of triggering a query answer, the method executable by a server communicatively coupled with a user device, the method comprising: acquiring a user query in a natural language; ranking a plurality of documents into a ranked list of documents based on respective document-query relevance scores, a given document-query relevance score being indicative of how relevant a given document from the plurality of documents is to the user query; determining, for a top N documents in the ranked list of documents using a first machine learning model, respective document-answer relevance scores, a given document-answer relevance score being indicative of how likely content from a given document amongst the top N documents is to satisfy the user query as an answer; ranking the top N documents into an other ranked list based on the respective document-answer relevance scores; generating, using a second machine learning model based on content snippets from a top M documents in the other ranked list, a query answer in the natural language; and triggering display of the query answer on the user device.

In some embodiments of the method, the method further comprises determining, using a search engine, a plurality of documents relevant to the user query.

In some embodiments of the method, the determining the plurality of documents relevant to the user query using the search engine further includes accessing a database in real-time.

In some embodiments of the method, the method further comprises generating a rephrased query using the user query, using the rephrased query instead of the user query for ranking the plurality of documents.

In some embodiments of the method, the method further comprises acquiring a query context associated with the user query, the query context comprising one or more dialogue strings in the natural language.

In some embodiments of the method, the generating the query answer is further based on the query context.

In some embodiments of the method, N is an integer.

In some embodiments of the method, M is an integer.

In some embodiments of the method, content from the given document amongst the top N documents is a text content.

In some embodiments of the method, content snippets from the top M documents in the other ranked list are text content snippets.

In a second broad aspect of the technology, there is provided a method of training a first machine learning model, the method comprising: training a third machine learning model based on a training set including: a training query, a training document, a first training answer and a second training answer, the first training answer and the second training answer having been generated based on content in the training document, the third machine learning model being trained in a pairwise manner to generate a logit value indicative of which one amongst the first training answer and the second training answer is a better training answer to the training query; generating, by the trained third machine learning model, an other logit value in a pointwise manner based on an other training query, an other training document, and an other answer having been generated based on content in the other training document; training the first machine learning model using an other training set including: the other training query, the other training document, and the other logit value, the first machine learning model being trained to predict the other logit value using the other training query and the other training document and indicative of how likely content from the other training document is to satisfy the training query if an answer is to be generated based on the content; using the first machine learning model for generating an in-use logit value based on an in-use query and an in-use document; if the in-use logit value is indicative of that in-use content of the in-use document is to satisfy the in-use query if an in-use answer is generated based on the in-use content, generating the in-use answer to the in-use query using the in-use content from the in-use document; and triggering display of the in-use answer on a user device.

In some embodiments of the method, the generation of the first training answer and the second training answer further includes sampling of a baseline answer.

In some embodiments of the method, training the first machine learning model using the other training set further includes iteratively adjusting at least one parameter of the first machine learning model to predict the other logit value.

In some embodiments of the method, training the first machine learning model further includes using at least one reinforcement learning model.

In yet another broad aspect of the present technology, there is provided a server for triggering a query answer, the server communicatively coupled with a user device, the server being configured to: acquire a user query in a natural language; rank a plurality of documents into a ranked list of documents based on respective document-query relevance scores, a given document-query relevance score being indicative of how relevant a given document from the plurality of documents is to the user query; determine, for a top N documents in the ranked list of documents using a first machine learning model, respective document-answer relevance scores, a given document-answer relevance score being indicative of how likely content from a given document amongst the top N documents is to satisfy the user query as an answer; rank the top N documents into an other ranked list based on the respective document-answer relevance scores; generate, using a second machine learning model based on content snippets from a top M documents in the other ranked list, a query answer in the natural language; and trigger display of the query answer on the user device.

In some embodiments of the server, the server is further configured to determine, using a search engine, a plurality of documents relevant to the user query.

In some embodiments of the server, the determining the plurality of documents relevant to the user query using the search engine further includes accessing a database in real-time.

In some embodiments of the server, the server is further configured to generate a rephrased query using the user query, using the rephrased query instead of the user query for ranking the plurality of documents.

In some embodiments of the server, the server is further configured to acquire a query context associated with the user query, the query context comprising one or more dialogue strings in the natural language.

In some embodiments of the server, the generating the query answer is further based on the query context.

In some embodiments of the server, N is an integer.

In some embodiments of the server, M is an integer.

In some embodiments of the server, content from the given document amongst the top N documents is a text content.

In some embodiments of the server, content snippets from the top M documents in the other ranked list are text content snippets.

In yet another broad aspect of the present technology, there is provided a server for training a first machine learning model, the server being configured to: train a third machine learning model based on a training set including: a training query, a training document, a first training answer and a second training answer, the first training answer and the second training answer having been generated based on content in the training document, the third machine learning model being trained in a pairwise manner to generate a logit value indicative of which one amongst the first training answer and the second training answer is a better training answer to the training query; generate, by the trained third machine learning model, an other logit value in a pointwise manner based on an other training query, an other training document, and an other answer having been generated based on content in the other training document; train the first machine learning model using an other training set including: the other training query, the other training document, and the other logit value, the first machine learning model being trained to predict the other logit value using the other training query and the other training document and indicative of how likely content from the other training document is to satisfy the training query if an answer is to be generated based on the content; use the first machine learning model for generating an in-use logit value based on an in-use query and an in-use document; if the in-use logit value is indicative of that in-use content of the in-use document is to satisfy the in-use query if an in-use answer is generated based on the in-use content, generate the in-use answer to the in-use query using the in-use content from the in-use document; and trigger display of the in-use answer on a user device.

In some embodiments of the server, the generation of the first training answer and the second training answer further includes sampling of a baseline answer.

In some embodiments of the server, training the first machine learning model using the other training set further includes iteratively adjusting at least one parameter of the first machine learning model to predict the other logit value.

In some embodiments of the server, training the first machine learning model further includes using at least one reinforcement learning model.

In the context of the present technology, “neural model” refers to an AI based model simulating interconnected neural structures to process large datasets. It is used in tasks such as language understanding and generation, allowing the system to learn patterns from data through layers of connected nodes.

In the context of the present technology, “machine learning” refers to a subset of AI where algorithms enable systems to automatically learn from data and improve their performance over time without being explicitly programmed. The model learns patterns and relationships within the data and applies these learned insights to make predictions or decisions in various tasks, such as language processing, image recognition, and recommendation systems.

In the context of the present technology, “Generative Pre-trained Transformer” (GPT) refers to a neural network model trained on extensive and diverse text data. It is designed to generate human-like text by predicting the next word or sequence based on previous context.

In the context of the present technology, a “generative model” refers to an AI model, such as a GPT-like model, that creates new data, such as text or answers, based on patterns learned from vast amounts of training data. It is designed to generate contextually appropriate and coherent answers by predicting the next sequence of words, given an input query and relevant source documents.

In the context of the present technology, “Large Language Model” (LLM) refers to a machine learning model trained on large-scale textual datasets. These models are designed to handle a wide range of language processing tasks, such as generating text, summarization, translation, and answering questions by understanding context and semantics.

In the context of the present technology, “Natural Language Processing” (NLP) refers to a branch of AI that focuses on the interaction between computers and human language. It enables systems to understand, interpret, and generate language in a way that is both meaningful and contextually accurate.

In the context of the present technology, “Supervised Fine-Tuning (SFT)” refers to a method used in machine learning for fine-tuning pre-trained models such as LLMs. It involves training the model on labeled data, leveraging the language understanding gained from previous training and applying it to a specific task.

In the context of the present technology, “reinforcement learning” refers to a machine learning method where a decision-making entity, for example, a software program or an algorithm, learns through interaction with its environment. It receives feedback in the form of rewards or penalties for actions taken, allowing it to optimize future decisions to achieve better results. This iterative process is used to enhance system performance over time.

In the context of the present technology, “search engine” refers to a system that retrieves, ranks, and presents relevant documents from a web index to find answer to a user's query.

In the context of the present technology, “indexing” refers to the process where a search engine organizes and stores web content in a searchable format. This index allows the search engine to quickly retrieve and rank documents based on the user's query.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 is a schematic diagram depicting a system, the system being implemented in accordance with non-limiting embodiments of the present technology.

FIG. 3 illustrates an exemplary workflow for query processing and answer generation, in accordance with at least some non-limiting embodiments of the present technology.

FIG. 4 illustrates an exemplary workflow for training a third machine learning (ML) model, in accordance with at least some non-limiting embodiments of the present technology.

FIG. 5 illustrates an exemplary workflow for the inference stage of the third ML model, in accordance with at least some non-limiting embodiments of the present technology.

FIG. 6 illustrates an exemplary workflow for training a first ML model, in accordance with at least some non-limiting embodiments of the present technology.

FIG. 7 is a scheme-block illustration of a method executed by a server of the computing device of FIG. 2, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

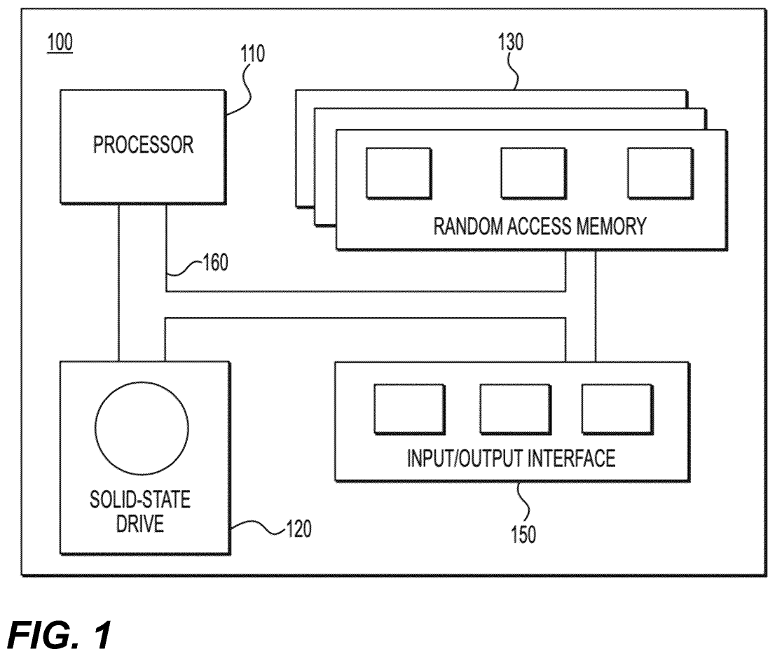

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

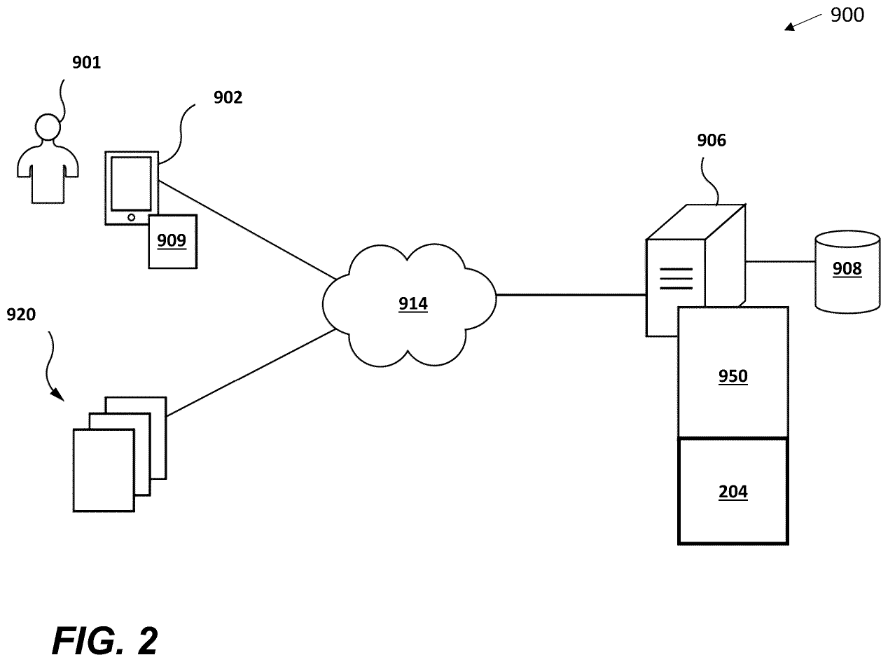

FIG. 2 is a schematic diagram of a system 900, the system 900 being suitable for implementing non-limiting embodiments of the present technology. It is to be expressly understood that the system 900 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 900 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 900 may provide in certain instances simple implementations of the present technology, and that where such is the case they have been presented in this manner as an aid to understanding. As persons skilled in the art would understand, various implementations of the present technology may be of a greater complexity.

The system 900 comprises an electronic device 902. The electronic device 902 is associated with a user 901 and, as such, can sometimes be referred to as a “client device” or “user device”. It should be noted that the fact that the electronic device 902 is associated with the user does not mean to suggest or imply any mode of operation—such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 902 may comprise a permanent storage (not depicted) in a form of one or more storage media and generally provides a place to store computer-executable instructions executable by a processor (not depicted). By way of example, the permanent storage may be implemented as a computer-readable storage medium including Read-Only Memory (ROM), hard disk drives (HDDs), solid-state drives (SSDs), and flash-memory cards.

The electronic device 902 comprises hardware and/or software and/or firmware (or a combination thereof), as is known in the art to execute a browser application (not depicted). Generally speaking, the purpose of the browser application (not depicted) is to enable the user 901 to access one or more web resources. The manner in which the browser application (not depicted) is implemented is known in the art and will not be described herein. Suffice to say that the browser application (not depicted) may be one of Google Chrome, or other commercial or proprietary browsers.

Irrespective of how the browser application (not depicted) is implemented, the browser application (not depicted), typically, has a command interface (not depicted) and a browsing interface (not depicted). Generally speaking, the user 901 can access a given web resource by entering an address of the web resource (typically an URL or Universal Resource Locator, such as www. example. com) into the command interface, or by clicking a link in an email or in another web resource for being redirected to the given web resource, and in turn, content of the given web resource may be displayed in the browsing interface for the user 901.

Alternatively, the given user 901 may conduct a search using a search engine service to locate a resource of interest based on the user's search intent. The latter is particularly suitable in those circumstances, where the given user knows a topic of interest, but does not know the URL of the web resource she is interested in. In FIG. 2, there is depicted a search engine 204 configured to performed one or more searches based on one or more queries provided thereto, as is known in the art. The search engine 204 typically returns a Search Engine Result Page (SERP) containing links to one or more web resources that are responsive to the user query. Again, upon the user clicking one or more links provided within the SERP, the user can open the required web resource.

In some embodiments of the present technology, the user 901 may make use of the browser application (not depicted) for accessing a chatbot application 950. Generally speaking, the chatbot application 950 refers to one or more computer-implemented algorithms that enable the server 906 to provide automated conversation services for the user 901 of the electronic device. For example, the user 901 may input queries or requests into the chatbot application 950, which is processed and answered by the chatbot application 950 using natural language processing (NLP) algorithms. As it will become apparent form the description herein further below, the chatbot application 950 may be configured to exchange information with the search engine 204 for integrating search-engine capabilities into the chatbot application 950. It is contemplated that the chatbot application 950 may be configured to execute one or more ML models such as LLMs, for example. The chatbot application 950 may be referred to as an LLM-based system because it may include one or more LLMs.

In some embodiments of the present technology, in addition to, or instead of, the electronic device 902 may be configured to execute a device-side chatbot application (not depicted) associated with the server-side chatbot application 950. Broadly speaking, the purpose of the device-side chatbot application is to enable the user 901 to: interact with the chatbot interface, input queries or requests in natural language, receive answers generated by the chatbot, access conversation history, provide follow-up questions or clarifications, adjust chatbot settings, and manage personalized data, such as user preferences or context-specific details.

Irrespective of whether the user 901 makes use of the browser application (not depicted) and/or the device-side chatbot application (not depicted) for accessing the chatbot service, it is contemplated that the user 901 may be provided with a chatbot interface for performing one or more actions related to the user's query or dialogue with the chatbot.

The electronic device 902 further comprises a communication interface (not depicted) for two-way communication with a communication network 914 via a communication link (not numbered). In some non-limiting embodiments of the present technology, the communication network 914 can be implemented as the Internet. In other embodiments of the present technology, the communication network 914 can be implemented differently, such as any wide-area communication network, local area communications network, a private communications network and the like.

How the communication link is implemented is not particularly limited and depends on how the electronic device 902 is implemented. Merely as an example and not as a limitation, in those embodiments of the present technology where the electronic device 902 is implemented as a wireless communication device (such as a smart phone), the communication link can be implemented as a wireless communication link (such as, but not limited to, a 3G communications network link, a 4G communications network link, a Wireless Fidelity, or WiFi, for short, Bluetooth, or the like) or wired (such as an Ethernet based connection).

It should be expressly understood that implementations for the electronic device 902, the communication link and the communication network 914 are provided for illustration purposes only. As such, those skilled in the art will easily appreciate other specific implementational details for the electronic device 902, the communication link and the communication network 914. As such, by no means the examples provided hereinabove are meant to limit the scope of the present technology.

The system 900 further includes a plurality of web servers 920 coupled to the communication network 914. A given one of the plurality of web servers 920 can be implemented as a conventional computer server. In an example of an embodiment of the present technology, the given web server can be implemented as a Dell PowerEdge Server running the Microsoft Windows Server operating system. Needless to say, the given web server can be implemented in any other suitable hardware and/or software and/or firmware or a combination thereof.

In some embodiments of the present technology, and generally speaking, the plurality of web servers 920 function as repositories for web resources. In the context of the present specification, the term “web resource” refers to any network resource (such as a web page, web site), which its content is presentable visually by the electronic device 902 to the user, via the browser application (not depicted), and associated with a particular web address (such as a URL).

A given web resource hosted by one or more of the plurality of web servers 920 may be accessible by the electronic device 902 via the communication network 914, for example, by means of the user typing in the URL in the browser application (not depicted), or executing a web search using the search engine 204. Needless to say, in some cases, a given web server amongst the plurality of web servers 920 may host one or more web resources, while in other cases, a given web resource may be hosted by one or more web servers amongst the plurality of web servers 920.

It is contemplated that one or more of the plurality of web servers 920 may be configured to provide web pages that a search engine crawler can visit, download, organize, and add to the search engine's database, as is known in the art.

The system 900 further includes a server 906 coupled to the communication network 914. The server 906 can be implemented as a conventional computer server. In an example of an embodiment of the present technology, the server 906 can be implemented as a Dell PowerEdge Server running the Microsoft Windows Server operating system. Needless to say, the server 906 can be implemented in any other suitable hardware and/or software and/or firmware or a combination thereof. In the depicted non-limiting embodiment of the present technology, the server 906 is a single server. In alternative non-limiting embodiments of the present technology, the functionality of the server 906 may be distributed and may be implemented via multiple servers.

The implementation of the server 906 is well known. However, briefly speaking, the server 906 comprises a communication interface (not depicted) structured and configured to communicate with various entities (such as the electronic device 902 and other devices potentially coupled to the communication network 914) via the communication network 914.

Similar to the electronic device 902, the server 906 comprises one or more storage media and generally provides a place to store computer-executable program instructions executable by one or more processors (not depicted) of the server 906. By way of example, the one or more storage media may be implemented as tangible computer-readable storage medium including Read-Only Memory (ROM) and/or Random-Access Memory (RAM) and may also include one or more fixed storage devices in the form of, by way of example, hard disk drives (HDDs), solid-state drives (SSDs), and flash-memory cards.

In some embodiments, the server 906 can be operated by the same entity that has provided the afore-described browser application (not depicted) and/or the afore-described device-side chatbot application. In alternative embodiments, the server 906 can be operated by an entity different from the one who has provided the aforementioned browser application (not depicted).

In accordance with non-limiting embodiments of the present technology, the server 906 may be configured to host the (server-side) chatbot application 950. It should be noted that the server 906 may be under control of a chatbot service provider.

Similarly, the chatbot application 950 may be accessible by the electronic device 902 by entering the associated URL (such as chatbot. example. com, or the like) into the command interface of the browser application (or clicking a hyperlink associated therewith) and/or by executing the aforementioned device-side chatbot application. Once the chatbot application 950 is accessed, the electronic device 902 may be configured to display the chatbot interface to the user 901 for enabling user interactivity between the user 901 and the chatbot service. In some embodiments of the present technology, the user 901 may need to “log in” to the chatbot service for being displayed with the chatbot interface.

The server 906 has access to a database 908. Broadly speaking, the chatbot application 950 may make use of the database 908 for providing chatbot services to its users. For example, the server 906 may be configured to maintain, within the database 908, user interactions, queries, and associated data needed for generating answers to the user 901 of the electronic device 902. It should be noted that when the user 901 of the electronic device 902 interacts with the chatbot application 950 (for example, by submitting a query), the user can be thought of as the intended recipient of the chatbot's generated answer.

It is contemplated that the server 906 may be configured to access the database 908 to retrieve data or information relevant to the query submitted by the user 901 of the electronic device 902. For example, the server 906 may retrieve the appropriate information based on the context or content of the user's query by matching it to relevant data sources or preprocessed documents stored within the database 908, which may be used to generate an answer through the chatbot application 950.

In some embodiments, the database 908 may be configured to store information associated with user queries and the corresponding answers generated by the chatbot application 950. Additionally, the database 908 can also maintain the following information: the timestamp of when the query was received, the timestamp of when an answer was generated or delivered, user ID, the time zone of the user, actions the user has taken in association with the answer (if any), the type of electronic device used to interact with the chatbot, the platform and/or operating system of the electronic device, sequential number of interactions with the chatbot, socio-demographic information about the user, and the like.

The database 908 may also store behavioral data associated with interactions of users of the chatbot application 950 with queries and answers exchanged through the chatbot. In some embodiments, the behavioral data may be stored in the database 908 in association with respective user accounts. For example, the database 908 may store a list of query categories and/or conversation types (pre-determined and/or personalized) associated with a given user account of the chatbot application 950, such as but not limited to: “personal inquiries,” “financial advice,” “product information,” “technical support,” “general knowledge,” and the like. Needless to say, the examples provided herein are meant to be non-limiting and non-exhaustive, and other categories (as well as number of pre-set categories) can be used. In another example, behavioral data may include data indicative of user interactivity between a given user and the chatbot and may be stored in the database 908 in association with the respective user account.

It is contemplated that the user device 902 or the server 906 depicted in FIG. 2 can be implemented using the computer environment of FIG. 1.

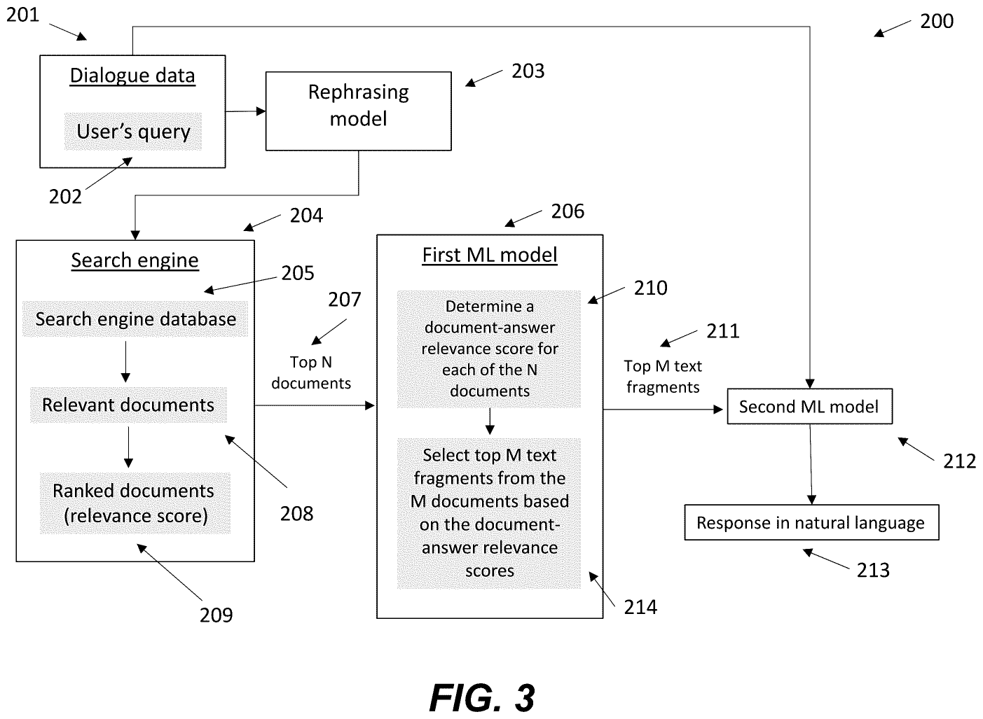

FIG. 3 illustrates an exemplary workflow 200 for query processing and answer generation, in accordance with at least some non-limiting embodiments of the present technology. In this embodiment, the process 200 begins with a dialogue data 201 between the user and the server 906 shown in FIG. 2. From the dialogue data 201, the server 906 extracts a user query 202.

As it will become apparent from the description herein further below, the server 906 may be configured to execute the chatbot application 950 with search engine capabilities (such as capabilities of the search engine 204, for example). That is, the server 906 may be configured to execute the chatbot application 950 to have a dialogue with the user 901, thereby generating the dialogue data 201 where the language model's natural language processing capabilities are combined with real-time information retrieval from the search engine. For example, the chatbot application 950 may interpret the user's queries, generate answers, and guide conversation flow during the dialogue, while the search engine 204 retrieves current or specialized data that the model may not have access to. This is particularly useful for queries requiring up-to-date information, such as recent events, for example.

Broadly speaking, when a user asks about something recent, the chatbot application 950 may analyze intent behind the query and generate a search query. The search engine 204 may make use of the search query and return relevant results. The chatbot application 950 may be configured to process and summarize the results, transforming them into concise, conversational answers tailored to the user's needs. The real-time search integration allows the system to stay updated on evolving topics, offering more accurate and timely information. This not only addresses the inherent knowledge cutoff of the one or more LLMs included in the chatbot application 950, but also aids the chatbot application 950 to respond effectively. The ability to refine searches and follow up with additional questions further enhances user satisfaction by offering more interactive and personalized dialogue. However, it should be noted that the search engine 204 may provide a large volume of results, and selecting best sources for generating query answers may be a difficult task.

In the embodiment of FIG. 3, the server 906 is configured to use a rephrasing module 203 to process the user's query 202. The rephrasing model 203 may take into account the contextual information from the dialogue data 201 between the user and the chatbot application 950 and formulate the rephrased query based on recent exchanges in the dialogue data 201. For example, in a dialogue, the user may ask, “Chuck Palahniuk's Most Popular Book,” and the server 906 may respond with “Chuck Palahniuk's most famous novel is Fight Club. A film of the same name was made based on it in 1999”. The next user query may be, “When was it written”. Without the context in the dialogue data 201, this follow-up question alone would not be enough for a search engine 204 to generate an appropriate answer. However, using contextual information in the dialogue data 201, the rephrasing model 203 may formulate the rephrased query as, “When was the book ‘Fight Club’ by Chuck Palahniuk written?”

The server 906 forwards the rephrased query to a search engine 204, which accesses a search engine database 205 in real-time to retrieve a set of relevant documents 208. In some embodiments, the search engine database 205 may be implemented using known techniques. The search engine 204 ranks these documents based on their relevance to the query, thereby generating a list of ranked documents 209.

Broadly speaking, the search engine 204 is configured to generate a ranked list of search results by determining a document-query relevance score to respective documents, which is indicative of how relevant a given document is to the user's query. This process may begin with the search engine 204 matching the query against its indexed documents. Each document is then evaluated based on a combination of factors that contribute to its document-query relevance score.

For example, the document-query relevance score is typically calculated using various techniques that assess how well a document aligns with the query. One approach involves keyword matching, where the search engine 204 checks if the query terms appear in important parts of the document, such as the title, content, and metadata. However, the document-query relevance score is not solely based on keyword presence. Other methods include techniques that consider factors like the frequency of query terms in a document compared to their frequency across the entire document set. Other known techniques may be employed by the search engine 204 without departing from the scope of the present technology. After determining the document-query relevance scores for a set of documents, the search engine 204 ranks the documents from highest to lowest document-query relevance.

From the ranked documents, the server 906 selects the top N documents 207 and sends them to the first ML model 206. N may be an integer pre-determined by the operator of the server 906. The first ML model 206 determines a document-answer relevance score for each document, as indicated by 210 in FIG. 3. The document-answer relevance score for a document is indicative of a likelihood that a content of the given document is susceptible to generating a relevant answer to the user query. The top N documents 207 may be re-ranked based on the document-answer relevance scores.

The server 906 may select a top M documents 214 in the re-ranked list of documents and extract text fragments from respective ones from the top M documents. For example, M content snippets or text fragments 211 from the re-ranked documents based on the document-answer relevance scores may be extracted from the top M documents in the re-ranked list of documents. The top M text fragments 211 are provided to a second ML model 212. The second ML model 212 may use the top M text fragments 211 to generate an answer 213 in natural language. In some embodiments, the second ML model 212 may be implemented using a GPT-like model.

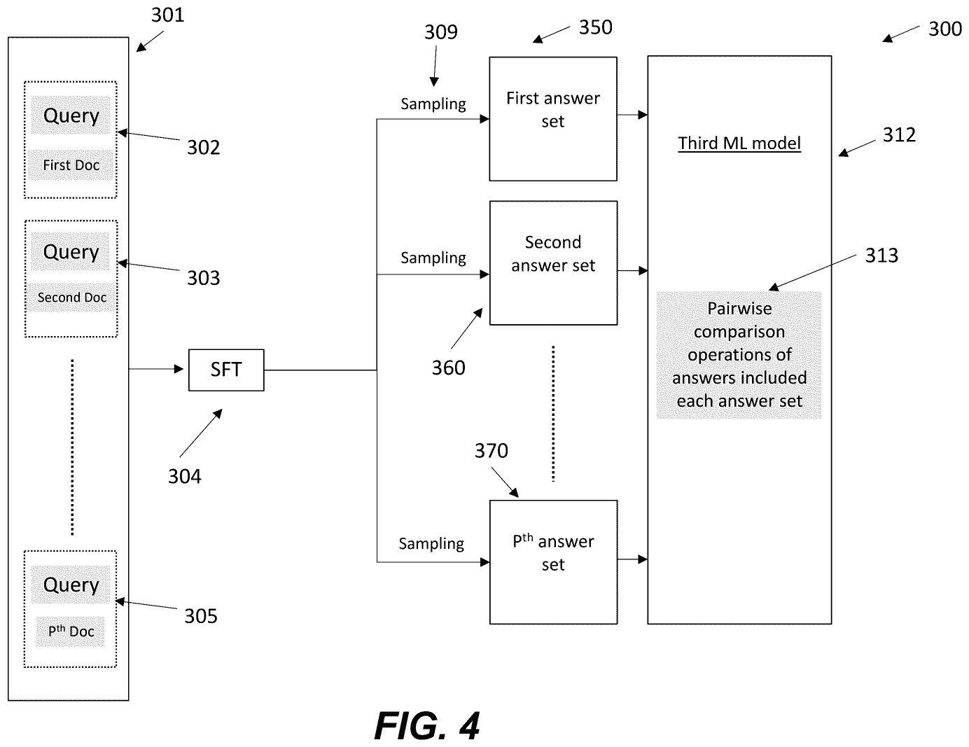

In some embodiments, the workflow illustrated in FIG. 3 may rely on various trained models to generate answers. Some embodiments may use a third ML model (depicted in FIG. 4), which assesses the quality of generated answers, to train the first ML model 206.

FIG. 4 illustrates a workflow 300 for training the third ML model 312, in accordance with at least some non-limiting embodiments of the present technology. In this embodiment, the workflow 300 begins with a set 301 of query-document pairs, including P number of pairs including pairs 302, 303, 305. The server 906 passes these query-document pairs to a supervised fine-tuning (SFT) model 304, which generates baseline answers for each query-document pair.

Broadly speaking, an SFT model is trained using labeled data to adapt a pre-trained model to a specific task. The process starts with a model that has already been trained on a large, general dataset, where it has learned broad features and patterns, such as understanding language, for example. During fine-tuning, the SFT model is provided with task-specific labeled data, and its parameters are adjusted through supervised learning operation. This involves comparing the model's predictions with the correct labels and updating its weights to improve accuracy for the particular task. The fine-tuning process allows the SFT model to retain the general knowledge gained during pre-training while becoming specialized for tasks like sentiment analysis and/or text classification. The SFT model is optimized to reduce the difference between its predictions and the labeled data, leading to improved performance on the specific task. By leveraging the pre-trained model's existing knowledge, a fine-tuning process is faster and more efficient than training a model from scratch.

The SFT model 304 may apply sampling 310 to produce multiple variations of each baseline answer to generate answer sets 350, 360, 370. Each of the answer sets 350, 360, 370 includes a plurality of answers for respective query-document pairs. For example, answer set 350 includes answers generated based on the content of query-document pair 302, answer set 360 includes answers generated based on the content of query-document pair 303, answer set 370 includes answers generated based on the content of query-document pair 305.

Broadly speaking, sampling techniques may be used generating a variety of outputs from the SFT model, especially in tasks like text generation. Sampling techniques help introduce variety into the SFT model's answers rather than producing the same deterministic result each time. One basic method is greedy search, where the SFT model selects the highest-probability token at each step. Other sampling techniques may be used, such as top-k sampling, for example, where the SFT model can choose from the top k most likely tokens, promoting more diverse results. Top-p sampling (nucleus sampling) techniques may also be used tokens are selective from a smallest group whose cumulative probability exceeds a pre-determined threshold, balancing diversity and coherence dynamically.

The answer sets 350, 360, 370 are passed to the third ML model 312 for pairwise comparison operations 313. In pairwise comparison operations, every possible pair of answers in a set is evaluated against each other. For n answers in a set, the third ML model 312 conducts n(n−1)/2 pairwise comparison operations.

For example, with reference to the answer set 350 including a plurality of answers, the third ML model 312 compares the first answer among the plurality of answers with the second answer among the plurality of answers, the second answer among the plurality of answers with the third answer among the plurality of answers, the third answer among the plurality of answers with the fourth answer among the plurality of answers etc., continuing until all pairs of answers in 350 have been compared. Similarly, the answers in sets 360 and 370 also undergo pairwise comparison operations by the third ML model 312. Through pairwise comparison operations, the third ML model 312 is trained to evaluate and rank answers generated using a query-document pair.

It can be said that the third ML model 312 can be trained on a training set including a training query, a training document, as well as a first training answer and a second training answer. The first training answer and the second training answer are generated based on content in the training document. For example, the SFT model may use the pair 302 to generate more than one answers 350 based on the pair 302 (and more particularly the content of the document in the pair 302 in view of the query in the pair 302). As such, the third ML model 312 is trained in a pairwise manner to generate a logit value indicative of which one amongst the first training answer and the second training answer is a better training answer to the training query. This process can be repeated for a variety of different pairs of answers for the pair 302, and/or for different pairs of answers of other document-query pairs, without departing form the scope of the present technology.

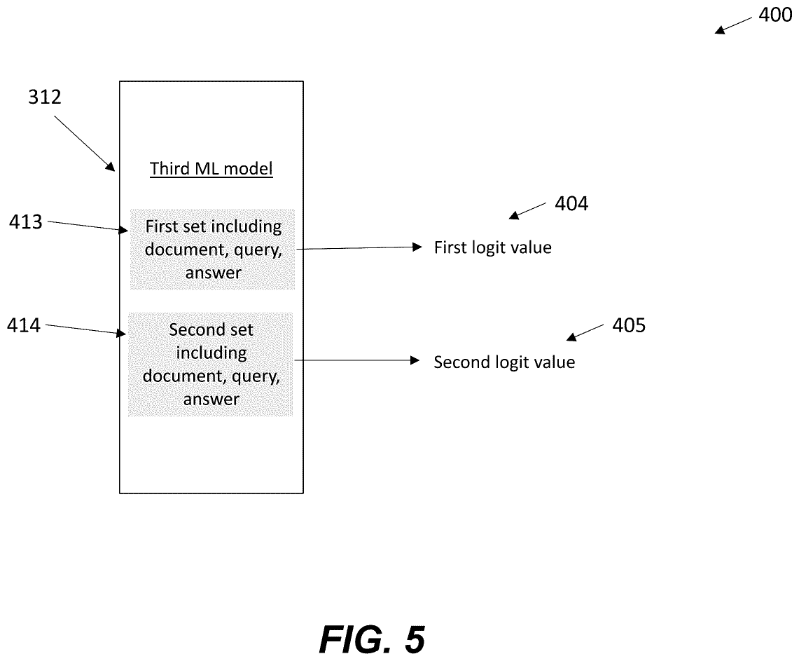

Once the third ML model 312 has been trained, as described in FIG. 4, the next stage involves utilizing this trained third ML model 312 for inference, as illustrated in FIG. 5, to generate logit values that assess the quality of answers for specific query-document pairs. In other words, the server 906 may use the third ML model 312 to generate labels for an other training dataset. The other training dataset may be sued to train the first ML model 206 depicted in FIG. 3, as will be described in greater details herein further below.

FIG. 5 illustrates an exemplary workflow 400 for the inference stage of the third ML model 312, in accordance with at least some non-limiting embodiments of the present technology. In this embodiment, although the third ML model 312 is trained in a pairwise manner to understand a better answer out of a given pair of answers, during inference, the third ML model 312 is configured to operate in a pointwise manner, and generate a logit value for a set, including an other document, and other query, and an other answer generated based on the content of the other document. The logit value generated by the third ML model 312 during inference may be used as a label for a training set to train the first ML model 206 depicted in FIG. 3.

For example, for the set 413 including the other document, the other query and the other answer, the third ML model 312 during inference may generate the first logit value 404. Similarly, for the set 414 including a different other document, a different other query and a different other answer, the third ML model 312 during inference may generate the second logit value 405. The first logit value 404, the document from the set 413, and the query from the set 413 may be used as a training set to train the first ML model 206. Similarly, the second logit value 405, the document from the set 414, and the query from the set 414 may be used as an other training set to train the first ML model 206. The training sets to train the first ML model 206 do not include any answers.

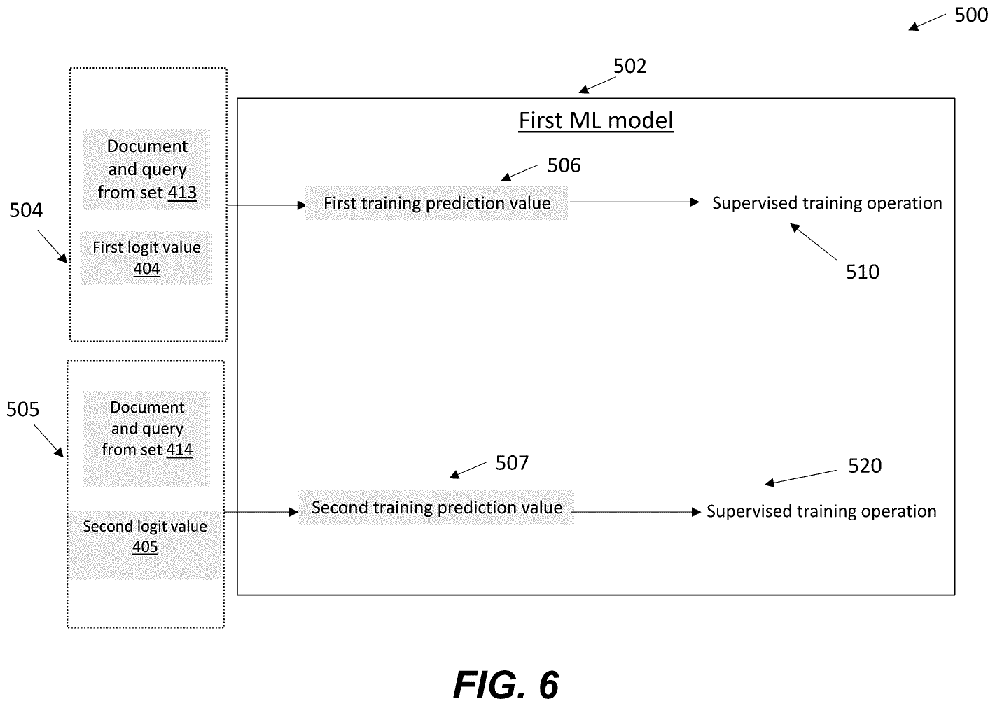

FIG. 6 illustrates an exemplary workflow 500 for training the first ML model 502, in accordance with at least some non-limiting embodiments of the present technology. In this embodiment, once the third ML model 312 (as referenced in FIG. 4 and FIG. 5) has generated logit values, for example, 404 and 405, corresponding to different document, query, and answer sets, for example, 413 and 414, the first ML model 502 is trained using training sets including those documents, queries and logit values. For example, the training set 504 includes the document and query from the set 413 and the first logit value 404 depicted in FIG. 5. Similarly, the training set 505 includes the document and query from the set 414 and the second logit value 405 depicted in FIG. 5. The training sets 504, 505 to train the first ML model 502 do not include any answers. The first ML model 502 receives the training sets 504 and 505.

The first ML model 502 uses the logit values from the training sets 504, 505 as target scores for training. During training, the first ML model 502 generates training prediction values. For example, the first training prediction value 506 is generated based on the document, query and logit value included in training set 504. Similarly, the second training prediction value 507 is generated based on the document, query and logit value included in training set 505.

The first ML model 502 is trained in a supervised manner based on the logit values in the training sets 504, 505 and the generated training prediction values 506, 507. The supervised training operation uses an iterative process to minimize the difference between the logit values included in the training sets and the respective generated training prediction values. For example, during supervised training operation 510, the parameters of the first ML model 502 are adjusted iteratively until the difference between the first training prediction value 506 and the first logit value 404 included in the training set 504 is reduced below a threshold value. Similarly, during supervised training operation 520, the parameters of the first ML model 502 are adjusted iteratively until the difference between the second training prediction value 507 and the second logit value 405 included in the training set 505 is reduced below a threshold value.

This iterative process trains the first ML model 502 to predict how good an answer would be if it were generated from any given query-document pair.

Optionally, it is contemplated that one or more reinforcement learning methods (not depicted) as is known in the art may be used in the context of the present technology.

The trained first ML model 502 may be used in the answer generation pipeline illustrated in FIG. 3.

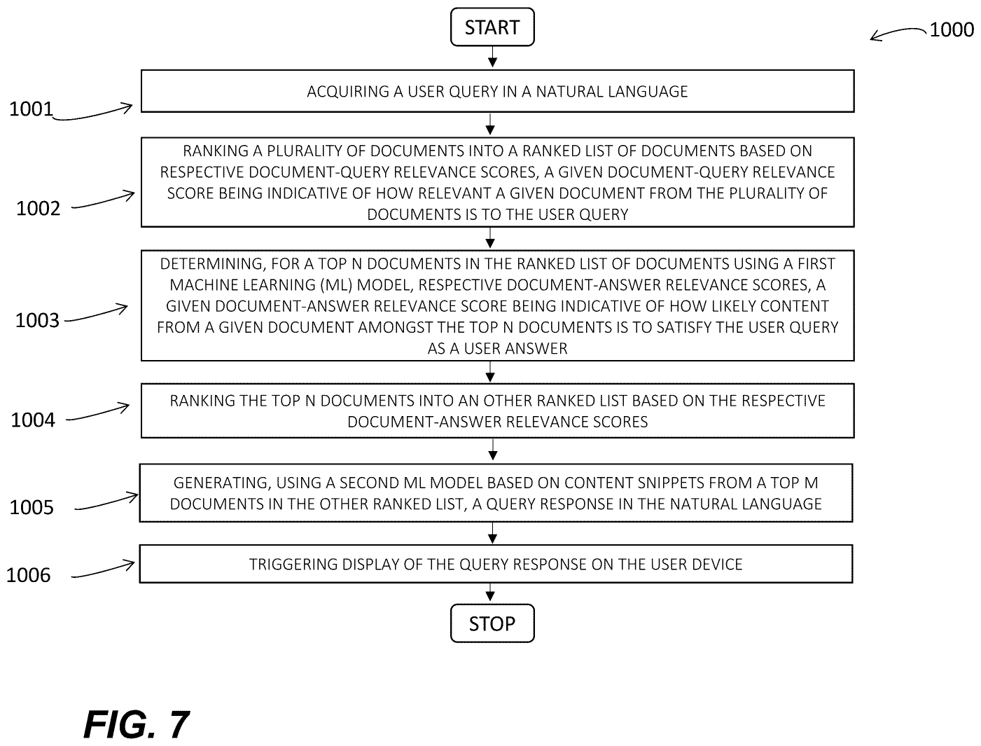

FIG. 7 is a scheme-block illustration of a method 1000, in accordance with at least some non-limiting embodiments of the present technology. In one or more aspects, the method 1000 or one or more steps thereof may be performed by the server 906 of the system 900 with reference to FIG. 2. The method 1000 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1000 starts with acquiring, at operation 1001, a user query in a natural language. For example, with reference to FIG. 2 and FIG. 3, the server 906 may be configured to acquire the user query 202 in a natural language.

The method 1000 continues with ranking, at operation 1002, a plurality of documents into a ranked list of documents based on respective document-query relevance scores, a given document-query relevance score being indicative of how relevant a given document from the plurality of documents is to the user query. For example, with reference to FIG. 2 and FIG. 3, the server 906 may be configured to use the search engine 204 to generate a list of ranked documents 209 from the plurality of relevant documents 208.

The method 1000 continues with determining, at operation 1003, for a top N documents in the ranked list of documents using a first machine learning model, respective document-answer relevance scores, a given document-answer relevance score being indicative of how likely content from a given document amongst the top N documents is to satisfy the user query as an answer. For example, with reference to FIG. 2 and FIG. 3, the server 906 may be configured to use the first ML model 206 to determine 210 a document-answer relevance score for each document included in the list of top N documents 207.

The method 1000 continues with ranking, at operation 1004, the top N documents into an other ranked list based on the respective document-answer relevance scores. For example, with reference to FIG. 2 and FIG. 3, the server 906 may be configured to re-rank the top N documents 207 based on the document-answer relevance scores. The server 906 may further be configured to select a top M documents 214 in the re-ranked list of documents and extract text fragments from respective ones from the top M documents. For example, M text fragments 211 from the re-ranked documents based on the document-answer relevance scores may be extracted from the top M documents in the re-ranked list of documents.

The method 1000 continues with generating, at operation 1005, using a second machine learning model based on content snippets from a top M documents in the other ranked list, a query answer in the natural language. For example, with reference to FIG. 2 and FIG. 3, the server 906 may be configured to use the second machine learning model 212 to generate an answer 213 in natural language using the top M content snippets or text fragments 211.

The method 1000 continues with triggering, at operation 1006, display of the query answer on the user device. For example, with reference to FIG. 2 and FIG. 3, the server 906 may be configured to trigger display of the query answer 213 on the user device 902.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 700 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of triggering a query answer, the method executable by a server communicatively coupled with a user device, the method comprising:
acquiring a user query in a natural language;
ranking a plurality of documents into a ranked list of documents based on respective document-query relevance scores, a given document-query relevance score being indicative of how relevant a given document from the plurality of documents is to the user query;
determining, for a top N documents in the ranked list of documents using a first machine learning model, respective document-answer relevance scores, a given document-answer relevance score being indicative of how likely content from a given document amongst the top N documents is to satisfy the user query as an answer;
ranking the top N documents into an other ranked list based on the respective document-answer relevance scores;
generating, using a second machine learning model based on content snippets from a top M documents in the other ranked list, a query answer in the natural language; and
triggering display of the query answer on the user device.

2. The method of claim 1, wherein the method further comprises determining, using a search engine, a plurality of documents relevant to the user query.

3. The method of claim 2, wherein the determining the plurality of documents relevant to the user query using the search engine further includes accessing a database in real-time.

4. The method of claim 1, wherein the method further comprises generating a rephrased query using the user query, using the rephrased query instead of the user query for ranking the plurality of documents.

5. The method of claim 1, wherein the method further comprises acquiring a query context associated with the user query, the query context comprising one or more dialogue strings in the natural language.

6. The method of claim 1, wherein the generating the query answer is further based on the query context.

7. The method of claim 1, wherein N is an integer.

8. The method of claim 1, wherein M is an integer.

9. The method of claim 1, wherein content from the given document amongst the top N documents is a text content.

10. The method of claim 1, wherein content snippets from the top M documents in the other ranked list are text content snippets.

11. A method of training a first machine learning model, the method comprising:
training a third machine learning model based on a training set including:
a training query,
a training document,
a first training answer and a second training answer, the first training answer and the second training answer having been generated based on content in the training document,
the third machine learning model being trained in a pairwise manner to generate a logit value indicative of which one amongst the first training answer and the second training answer is a better training answer to the training query;
generating, by the trained third machine learning model, an other logit value in a pointwise manner based on an other training query, an other training document, and an other answer having been generated based on content in the other training document;
training the first machine learning model using an other training set including:
the other training query,
the other training document, and
the other logit value,
the first machine learning model being trained to predict the other logit value using the other training query and the other training document and indicative of how likely content from the other training document is to satisfy the training query if an answer is to be generated based on the content;
using the first machine learning model for generating an in-use logit value based on an in-use query and an in-use document;
if the in-use logit value is indicative of that in-use content of the in-use document is to satisfy the in-use query if an in-use answer is generated based on the in-use content, generating the in-use answer to the in-use query using the in-use content from the in-use document; and
triggering display of the in-use answer on a user device.

12. The method of claim 11, wherein the generation of the first training answer and the second training answer further includes sampling of a baseline answer.

13. The method of claim 11, wherein training the first machine learning model using the other training set further includes iteratively adjusting at least one parameter of the first machine learning model to predict the other logit value.

14. The method of claim 11, wherein training the first machine learning model further includes using at least one reinforcement learning model.

15. A server for triggering a query answer, the server communicatively coupled with a user device, the server being configured to:
acquire a user query in a natural language;
rank a plurality of documents into a ranked list of documents based on respective document-query relevance scores, a given document-query relevance score being indicative of how relevant a given document from the plurality of documents is to the user query;
determine, for a top N documents in the ranked list of documents using a first machine learning model, respective document-answer relevance scores, a given document-answer relevance score being indicative of how likely content from a given document amongst the top N documents is to satisfy the user query as an answer;
rank the top N documents into an other ranked list based on the respective document-answer relevance scores;
generate, using a second machine learning model based on content snippets from a top M documents in the other ranked list, a query answer in the natural language; and
trigger display of the query answer on the user device.

16. The server of claim 15, wherein the server is further configured to determine, using a search engine, a plurality of documents relevant to the user query.

17. The server of claim 16, wherein the determining the plurality of documents relevant to the user query using the search engine further includes accessing a database in real-time.

18. The server of claim 15, wherein the server is further configured to generate a rephrased query using the user query, using the rephrased query instead of the user query for ranking the plurality of documents.

19. The server of claim 15, wherein the server is further configured to acquire a query context associated with the user query, the query context comprising one or more dialogue strings in the natural language.

20. The server of claim 15, wherein the generating the query answer is further based on the query context.
